(19) United States
(12) Patent Application Publication
(10) Pub. No.: US 2005/0263107 A1
(43) Pub. Date: Dec. 1, 2005

(54) Dog waste bag carrying device

(76) Inventor: Prodromos Pericles Stephanos, Walnut Creek, CA (US)

Correspondence Address: HOLLAND & KNIGHT LLP, 633 WEST FIFTH STREET, TWENTY-FIRST FLOOR, LOS ANGELES, CA, 90071-2040, US

(21) Appl. No.: 11/123,843

(22) Filed: May 6, 2005

Related U.S. Application Data
(60) Provisional application No. 60/568,942, filed on May 7, 2004.

(51) Int. Cl. A01K 23/00

(52) U.S. Cl. 119/867

(57) ABSTRACT

A device particularly adapted for carrying one or more plastic bags of the type used to gather a dog's excrement while walking the dog on a leash. The device comprises a flexible planar body portion, an attachment surface proximate one end of the body portion for securing the body portion to a dog leash and a plurality of slits extending through the body portion and intersecting at a common aperture so as to define a plurality of adjacent resilient fingers between the slits for engaging and pressing against a portion of one or more plastic bags inserted therethrough. A tether is preferably provided between the attachment surface and the leash for the securement of the device on the leash.

### CROSS-REFERENCE TO RELATED APPLICATIONS

This application claims the benefit of U.S. Provisional Patent Application Ser. No. 60/568,942, filed May 7, 2004.

### BACKGROUND OF THE INVENTION

The present invention relates to a device for conveniently carrying animal waste while walking one's dog. Dog owners in urban areas and in many rural areas are required to keep their dogs on a leash while taking the dog for a walk. Those owners also are required to clean up after their pets. Thus, a common problem facing pet owners is how to pick up and dispose of the dog's waste while walking the dog on a leash. The most common solution is to pick up the waste with a small plastic bag of the type obtained in grocery stores, twist or tie the bag so as to seal the waste therein and then carry the bag to a disposition site, all while continuing to walk the dog. This can present logistical nightmares when walking two dogs at the same time while carrying the waste and encountering another dog or cat. Even walking a single dog while carrying its excrement is unpleasant for many people and often results in disposing of the bag and its contents at the earliest possible opportunity which is not always appreciated by nearby property owners. The present invention provides a means for conveniently carrying the bag while continuing to walk the dog with a minimum of inconvenience thereby obviating the precarious situation described above and the urgency to dispose of the bag and its contents.

### SUMMARY OF THE INVENTION

Briefly, the present invention comprises a carrying device which is adapted to be readily attached to a conventional dog leash for carrying one or more empty plastic bags and/or a bag containing the dog's excrement in a sealed disposition. The carrying device of the present invention has an aperture extending therethrough for use in tethering the device to a dog leash and defines a generally planar body portion formed of a resilient plastic material that has a plurality of slits extending therethrough. The slits all intersect at a small common central aperture such that said slits define a plurality of adjacent, tapered, resilient fingers therebetween. Upon placing an object relatively light in weight such as a plastic bag through said central aperture, the formed fingers will bear against and hold the object in place.

In the preferred application, the carrying device of the present invention is used to carry a flexible plastic bag containing a dog's excrement by the bag's twisted end. After picking up the dog's excrement with the bag and twisting the open end of the bag to seal the waste therein, the twisting portion of a plastic bag is simply pushed through the small central aperture in the body portion of the device adjacent the intersection of the slits therein, the formed resilient fingers will separate to allow the passage of the twisted end of the bag therethrough and thereafter bear against and grip the twisted portion of the bag, holding that portion of the bag in its twisted disposition so as to prevent air flow therefrom while supporting and carrying the bag and its sealed contents. As a result, a dog's excrement then can be readily carried by the leash extending between the dog and its owner in an airtight disposition without requiring the owner to hold the bag while walking the dog. Thus, a person can walk their dog while having both hands continuously available to control the dog or one person can readily walk two dogs on two separate leashes while conveniently carrying the waste evacuated by one or both dogs while on their walk.

In addition to the above-described application, the bag carrying device of the present invention could also be attached to one's person, bicycle handle bars, inside cars and trucks, in the household, etc. and used to carry empty bags as well as a variety of other items.

### BRIEF DESCRIPTION OF THE DRAWINGS

FIG. 1 is a perspective view of the carrying device of the present invention.

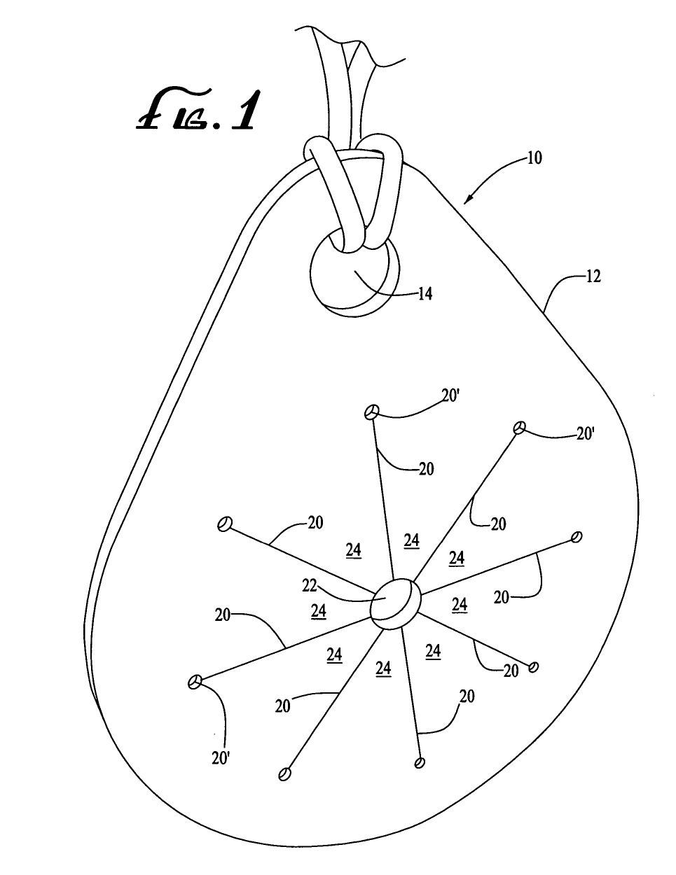

FIG. 2 is a perspective view of the carrying device of the present invention attached to a dog leash.

FIG. 3 is a perspective view of the carrying device of the present invention attached to a dog leash and carrying a filled waste disposal bag.

FIG. 4 is a perspective view of the carrying device of the present invention illustrating the flexible gripping fingers formed thereby.

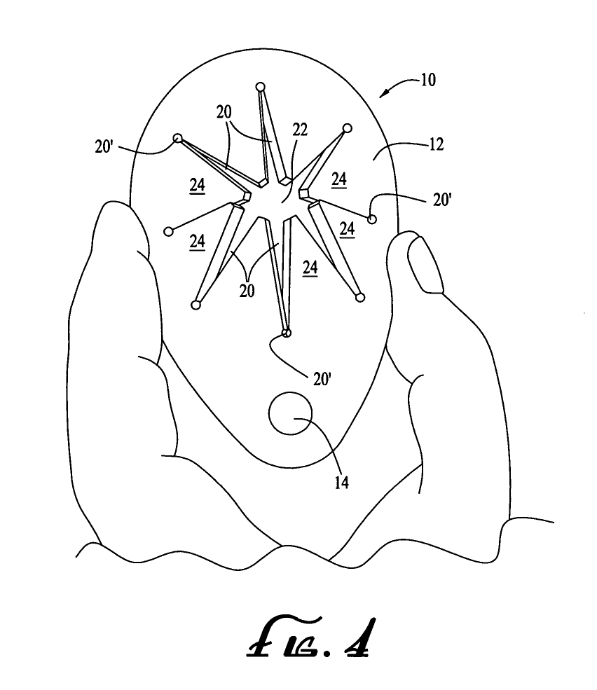

### DETAILED DESCRIPTION OF THE PREFERRED EMBODIMENT

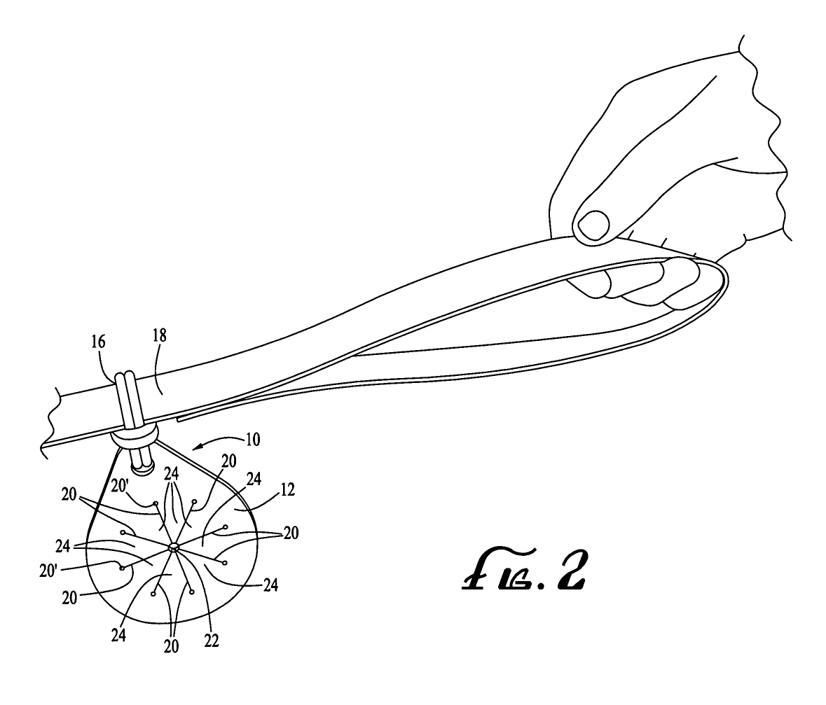

Referring now in detail to the drawings, the bag carrying device 10 of the present invention has body portion 12, is formed of resilient, plastic material, is of generally planar construction and defines an attachment aperture 14 therein adapted to receive a short resilient attachment cord 16 for securing the device to a conventional dog leash 18 intermediary of its ends as illustrated in FIG. 2. The body portion 12 also defines a plurality of intersecting radial slits 20 therein that extend through the body portion and intersect at a common location defined by a small central aperture 22 so as to define a plurality of adjacent, resilient and converging fingers 24 in a generally central area of the body portion of the bag carrying device 10. To prevent tearing of the body portion 12, each of the slits 20 preferably terminate at their outer ends in small rounded apertures 20′.

In use, a person walking their dog can insert one or more small plastic bags 25 through the carrying device 10 at aperture 22 whereupon the resilient fingers 24 will separate to allow the passage of the bag or bags therethrough and thereafter bear against and support the bags such that they do not need to be independently carried by the pet owner. By providing the small aperture 22 at the intersection of the slits 20, the inner ends of the resilient fingers are rounded to prevent tearing the bags.

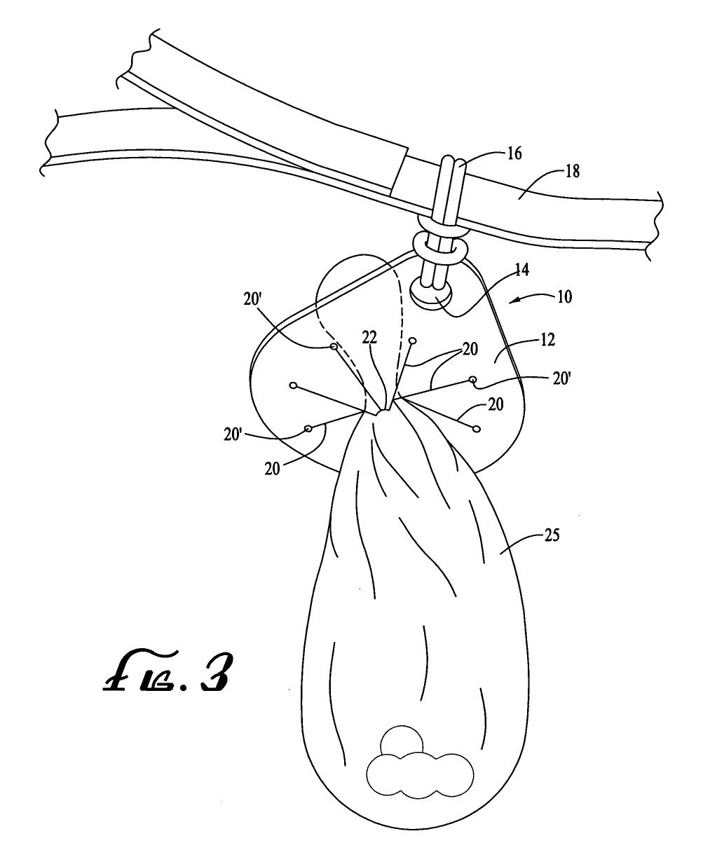

After the dog attends to its business, the owner can pull one of the bags from the device, insert his or her hand into the bag, pick up the excrement with the bagged hand, invert the bag about the excrement and seal the bag by twisting (or tying) its open end. The twisted end of the bag is then inserted back through aperture 22 adjacent the inwardly directed pointed ends of fingers 24. The resiliency in the fingers will cause the fingers to press against the twisted end of the bag, so as to maintain the end of the bag in a tight twisted disposition thereby maintaining the airtight closure of the bag as shown in FIG. 3. In addition, the resiliency in the fingers will support the weight of the bag and the animal waste contained therein so that they can be carried by the leash between the owner and the dog enabling the person walking the dog to continue walking the dog in a convenient manner while the bag excrement is carried by the leash. In this manner, the bag carrying device 10 enables the person walking his or her dog to use their hands solely to hold onto the leash or leashes to control their dog or dogs without having to concurrently carry the dog's waste in the same or other hand. The result is better control over their dog(s) and a much more pleasant walk for the owner.

By way of example, the bag carrying device 10 is formed of a resilient plastic material such as polyvinylchloride, approximately 0.125 inches thick so as to provide the flexibility and resiliency desired in the formed fingers 24 necessary to function as a carrying device in the manner above described. The small central aperture 22 provided at the point of intersection of slits 20 to round the ends of fingers 24 defines a diameter of about 0.125 in. Four equally-spaced slits 20 are utilized with each slit passing through the center of central aperture 22 so as to define eight tapered fingers 24 with each finger being about 1.125 in. in length. The small apertures 20′ at the outer ends of slits 20 are preferably about 2 mm. in diameter. The leash attachment aperture 14 is about 0.250 in. in diameter so as to receive a knotted 2 millimeter diameter elastic cord 16 defining a closed loop length of about 4.5 centimeters (see FIGS. 2 and 3). While various different tethers, including clips and other forms of attachment members, could be employed to secure the device 10 to a leash or a variety of other objects (support fixtures), elastic cord 16 provides a versatile looped securement for the device and one that will maintain the waste and/or disposal bag(s) in place on leashes of varying sizes and configurations without sliding up or down the leash.

It is to be understood that the aforesaid dimensions are by way of example only and could be varied without departing from the spirit and scope of the invention. For example, the size and configuration of the central aperture 22, the number of slits 20 and thus the number of fingers 24 could be varied as well as the length and width of the slits. Other resilient materials could also be used to form the device or the body of the device. As device 10 could be used to carry a wide variety of objects (e.g. towels, gloves, paint brushes, tools, paper items, clothing, etc.) other than the waste disposal bags discussed above, the configurations and dimensions of the various parameters defining the gripping fingers 24 would depend, at least in part, on the intended use of the carrying device. In addition, the device 10 could be permanently attached to an item such as a dog leash or formed as an integral part of the leash or other item. The device could also be sewn into clothing and used to carry objects. Further, by using a transparent material to form the carrying device 10, the device can be conveniently attached to other products at the point of purchase, without obliterating or otherwise obscuring the label of the other product at the point of sale. One could also place an additional item, e.g., promotional product or written material (not shown) in aperture 22 so that the additional item would be carried by the device 10 which in turn is carried by the base product. Thus, the carrying device 10 could be used as a point of sale co-pack device.

In a modification of the present invention (not shown), the carrying device could be enlarged, multiple pluralities of intersecting slits added and the resulting device used as a point of purchase rack display. In such an application, the body portion of the device could be several inches tall and wide and contain a plurality of sets of intersecting slits preferably arranged in rows and columns. Each individual set of slits would be similar to the single set employed in carrying device 10 and illustrated in the accompanying drawings. With a plurality of sets of slits, such a device would be adapted to receive and carry a corresponding plurality of products therein (e.g. writing pens, flashlight batteries, etc.) being offered for sale. Thus, on a single flat board formed of the same resilient plastic material described above, rows of products could be carried by the board with each individual product being held by a set of fingers. A purchaser would simply pull the object from the board thus obviating the need to individually package each item. For such applications, the number, width and length of the slits (20) as well as the size of the central apertures (22) could be designed for the particular products adapted to be carried by the board. It should be noted, however, that the intersecting slits and the resilient fingers formed by the slits allow a relatively large variance in the size and shape of the product to be held thereby without requiring any such modifications.

Various other changes and modifications may be made in carrying out the present invention without departing from the spirit and scope thereof. Insofar as these changes and modifications are within the purview of the appended claim, it is to be considered as part of the present invention.

1. A device for carrying one or more flexible plastic bags of the type used to gather a dog's excrement while walking a dog on a leash, said device comprising a generally flexible planar body portion, an attachment surface proximate one end of said body portion for securing the body portion to a dog leash, and a plurality of slits extending through said body portion and intersecting at a common aperture so as to define a plurality of adjacent resilient fingers between said slits for engaging and pressing against a portion of one or more plastic bags inserted therethrough such that upon filling one of said bags with a dog's excrement, twisting the open end of the bag so as to seal the excrement within the bag and inserting the twisted sealed end of the bag through said common location in said body portion, said fingers will press against the twisted end of the bag so as to maintain the end of the bag in a sealed disposition and support the excrement carrying bag on the leash.

2. The device of claim 1 including an elastic tether and wherein said attachment surface is defined by an aperture in said device.

3. The device of claim 1 wherein at least said body portion of said devices in formed of transparent polyvinylchloride.

4. A device adapted to be secured to a fixture for carrying one or more objects thereon, said device comprising a generally flexible planar body portion, an attachment surface proximate one end of said body portion for securing the body portion to the support fixture, and a plurality of slits extending through said body portion and intersecting at a common aperture so as to define a plurality of adjacent resilient fingers between said slits for engaging and pressing against a portion of one or more objects inserted therethrough whereby said objects will be secured to and carried by said device on the support fixture.
